(19) United States
(12) Patent Application Publication
(10) Pub. No.: US 2008/0101623 A1
(43) Pub. Date: May 1, 2008

(54) Device for Receiving Audio Signals Transmitted in a Wireless Manner

(76) Inventors: Achim Gleissner, Barienrode (DE); Heinrich Esser, Wedemark (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/662,465

(22) PCT Filed: Sep. 13, 2005
(86) PCT No.: PCT/EP05/09843

§ 371 Date: Apr. 5, 2007

(30) Foreign Application Priority Data
Sep. 14, 2004 (DE) 10 2004 044 924.4

(51) Int. Cl. H04B 3/00

(52) U.S. Cl. 381/77

(57) ABSTRACT

The invention is directed to a wireless transmission system with a transmitter and receiver which makes it possible to retrofit existing loudspeakers in such a way that a wireless audio transmission path is provided.

### CROSS-REFERENCE TO RELATED APPLICATIONS

This application claims priority of International Application No. PCT/EP2005/009843, filed Sep. 13, 2005 and German Application No. 10 2004 044 924.4, filed Sep. 14, 2004, the complete disclosures of which are hereby incorporated by reference.

### BACKGROUND OF THE INVENTION

a) Field of the Invention

The invention relates to a device for receiving audio signals transmitted in a wireless manner.

b) Field of the Invention

In many fields where data and signals are transmitted, transmission utilizing cables is being replaced by wireless transmission. In this way, for example, burdensome cabling can be avoided. Particularly in the transmission of audio signals, wireless transmission paths or transmission systems such as wireless headphones, wireless microphones and wireless in-ear monitors are sufficiently well known.

Further, wireless transmission systems are known in which, for example, a transmitter is connected to an audio signal source and the wireless receiver can be positioned anywhere in the room. An audio processing unit can then be connected to the wireless receiver. Loudspeakers with built-in radio receivers are another example for wireless audio signal transmission systems. However, wireless transmission in loudspeakers of this kind is a proprietary solution.

The wireless transmission systems mentioned above cannot ensure simple retrofitting or ease of use.

US 2003/0179889 A1 shows a wireless adapter for loudspeakers. The adapter has a high-frequency receiver for receiving the transmitted audio information. The received high-frequency audio signals are amplified by an amplifier and sent to an output to which a loudspeaker can be connected. The adapter is powered by standard line power.

DE 692 20 180 T2 shows an active sound reproduction device with an audio input for receiving an audio signal, a signal processing circuit for processing the audio signal, and a control input for receiving control signals. The active sound reproduction device can be controlled in a corresponding manner by remote control.

U.S. Pat. No. 5,970,390 shows a transmitter for transmitting audio signals to an FM radio. A control circuit detects an unused frequency within the FM transmission band and adjusts the frequency of the transmitter in a corresponding manner.

U.S. Pat. No. 4,434,509 shows a portable transistor radio with a receiver and a line power plug arranged at the housing.

### OBJECT AND SUMMARY OF THE INVENTION

Accordingly, it is the primary object of the present invention to provide a wireless transmission system with a transmitter and receiver which makes it possible to retrofit existing loudspeakers in such a way that a wireless audio transmission path is provided.

This object is met by a reception device for receiving wirelessly transmitted audio signals comprising a reception unit for receiving and decoding wirelessly transmitted signals, an audio amplifier unit for amplifying the decoded audio signals, an external audio output for outputting the amplified audio signals and a housing with a live power plug fastened to it. The reception unit and the audio amplifier are arranged in the housing. Further, in accordance with the invention, the object is met by a wireless audio transmission signal with a reception device as just described.

### BRIEF DESCRIPTION OF THE DRAWING

FIG. 1 shows a schematic view of a receiver according to the first embodiment example.

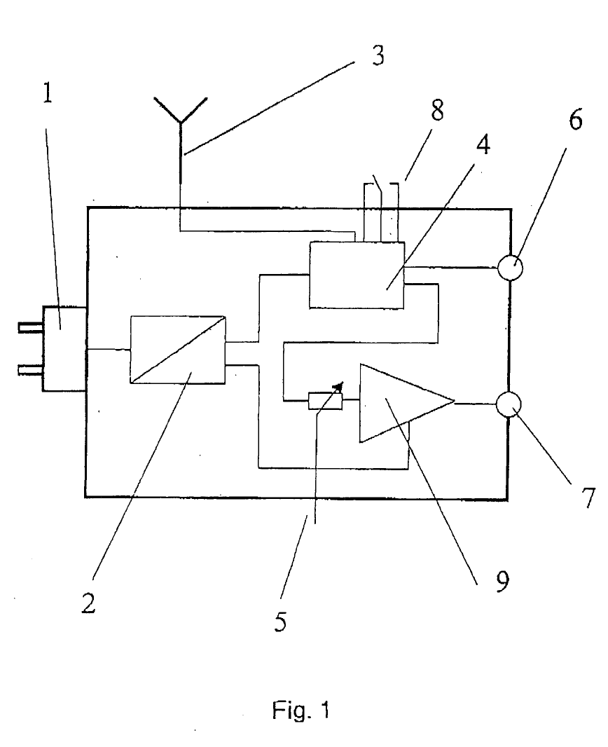

### DESCRIPTION OF THE PREFERRED EMBODIMENTS

The receiver has a radio reception unit 4, an antenna 3, an audio power amplifier unit 9, a power supply 2, and audio output connections or terminals 7. The receiver is fixedly connected to a plug 1 which can be inserted into commercially available sockets to ensure a power supply using line power. A loudspeaker (not shown) is preferably connected to the audio output terminals 7 for outputting audio signals. Further, the receiver has a volume control 5 by which the volume of the audio signal can be regulated.

A corresponding wireless transmitter is preferably likewise provided with a power supply utilizing line power. The wireless transmission of the audio signals to the receiver can be carried out by means of HF signals, IR signals, ultrasonic signals or other frequencies suitable for and open to wireless transmission. The transmitter can be connected to the line-out interface or other suitable interface of an audio source (not shown) by means of an audio cable and transmits the corresponding audio signals wirelessly.

The receiver is supplied with power by the power supply 2. The signal which is transmitted wirelessly by the transmitter is received and demodulated by means of the antenna 3 and the radio reception unit 4. The demodulated audio signal is sent to the audio power amplifier 9 whose output signal is sent to the output terminal 7. When a loudspeaker is connected to the terminal 7, the amplified demodulated audio signal can be reproduced by the loudspeaker. Since the receiver is fixedly connected to the plug 1, the plug, along with the receiver, can be plugged directly into a socket so that a corresponding power cable can be dispensed with. Alternatively, a detachable power cable can also be provided between the plug 1 and the receiver for supplying line voltage.

In addition to the components described above, the receiver can also have a switch 8. The switch 8 is used when the audio signal is transmitted as a multiplexed signal. When activated, the switch 8 determines whether the left stereo channel or the right stereo channel is correspondingly reproduced by the receiver. This means that the receiver is suitable both for receiving and for reproducing the left stereo channel or the right stereo channel, and only by actuating the switch 8 is it determined which channel is sent to the audio power amplifier 9 and accordingly to the external loudspeaker. Therefore, a left/right identification of a stereo signal can be carried out by means of the switch 8. This can be carried out, for example, by demultiplexing the received signal. The demultiplexed signal is then a mono signal which corresponds to the left channel or right channel of the stereo signal. Therefore, the entire stereo signal is transmitted, and it is selected by means of the switch 8 whether the right channel or left channel is amplified and correspondingly outputted.

As an alternative to the transmission of the stereo signal, a 5.1-surround audio signal can also be transmitted correspondingly. In this case, it is determined by means of the switch 8 which of the channels is amplified and outputted at the external loudspeaker. The entire 5.1-signal is likewise transmitted in this case, and it is determined by means of the switch 8 which of the transmitted channels should be amplified and outputted.

In addition to the terminal 7 for an external loudspeaker, the receiver can also have an additional second terminal 6 as a line-out output to which additional equipment may be connected so that a wireless audio transmission can be carried out between the equipment connected to the transmitter and the equipment connected to the receiver.

The receiver and the transmitter can each have a channel adjusting unit KEE. The transmission channel in the transmission path can be adjusted or selected by means of this unit. This can be carried out either manually or by means of a search function (auto-tuning).

According to a second embodiment example which is based on the first embodiment example, all or all substantial functions of the receiver can be adjusted by remote control. The remote control can be implemented in the transmitter or as an independent unit. In this case, the receiver according to the second embodiment example has no volume control 5 which can be externally adjusted; rather, the volume is changed by corresponding actuation of the remote control.

The remote control can be based on IR signals, ultrasonic signals, WLAN signals or Bluetooth signals. The remote control can communicate directly with the receiver or indirectly with the receiver via the transmitter. In case the remote control communicates directly with the receiver, the receiver has another reception unit for receiving the wirelessly transmitted signals from the remote control. In case the remote control communicates with the transmitter or with the receiver via the transmitter, the signal of the remote control can be added to the audio signal to be transmitted or can be encoded therein and then transmitted wirelessly together with it. In this case, a separate reception component for receiving the signals of the remote control can be omitted in the receiver.

In case the signals of the remote control are likewise transmitted to the receiver by the transmitter, the receiver further has a detection device for separating the wirelessly transmitted audio signals and the signals of the remote control. The signals of the remote control can then be used for adjusting the volume by means of the volume control 5, while the wirelessly transmitted audio signals can be processed and sent to the loudspeaker as is described in the first embodiment example.

According to a third embodiment example which is based on the second embodiment example, the transmitter is constructed as a wireless microphone. A volume control is provided at the wireless microphone for adjusting the volume of the audio signals outputted by the receiver. As in the second embodiment example, the transmission of the volume signals to the receiver can be carried out by means of IR signals, ultrasonic signals, WLAN signals or Bluetooth signals, assuming that the microphone has a suitable transmitter and the receiver has corresponding reception units. Alternatively, the volume signal can be encoded in the audio signal received from the microphone and transmitted along with this audio signal. In this case, the receiver has a corresponding detection device for separating the audio signal and volume signal from one another and processing them corresponding to the first embodiment example.

The above-described wireless signal transmission between the transmitter and the receiver can be carried out by means of HF signals, IR signals, ultrasonic signals, WLAN signals or Bluetooth signals. Alternatively, the transmission of the signals from the transmitter to the receiver can be carried out based on the line voltage from which the transmitter and the receiver draw their supply voltage, i.e., signal transmission via power line. In this case, the transmitter must have a corresponding transmitting unit and the receiver must have a corresponding reception unit.

While the foregoing description and drawings represent the present invention, it will be obvious to those skilled in the art that various changes may be made therein without departing from the true spirit and scope of the present invention.

What is claimed is:

1-11. (canceled)

12. A reception device for receiving wirelessly transmitted audio signals comprising:
a reception unit for receiving and decoding wirelessly transmitted audio signals;
an audio amplifier unit for amplifying the decoded audio signals;
an external audio output for outputting the amplified audio signals;
a housing with a line power plug fastened to it; and
said reception unit and said audio amplifier unit being arranged in the housing.

13. The reception device according to claim 12, further having a switch unit for selecting a channel from a plurality of audio channels transmitted with the audio signal.

14. The reception device according to claim 12, further having a volume control for adjusting the volume of the amplified audio signals outputted at the external audio output. ;

15. The reception device according to claim 12, further having a line-out output terminal.

16. The reception device according to claim 12, further having a channel adjusting unit.

17. The reception device according to claim 16, wherein the channel adjusting unit is designed to carry out a search function for channel adjustment.

18. A reception device for receiving wirelessly transmitted audio signals, comprising:
a reception unit for receiving and decoding wirelessly transmitted audio signals;
an audio amplifier unit for amplifying and outputting the decoded audio signals;
an external audio output for outputting the amplified audio signals; and
a detection device for detecting the transmitted audio signals and for separating them from other signals encoded in the audio signal.

19. The reception device according to claim 18, wherein the amplification of the audio signal is carried out in the audio amplifier unit corresponding to the signals separated from the audio signal.

20. The reception device according to claim 18, further having a detection device for receiving wirelessly transmitted control information, wherein the operation of the reception device is controlled corresponding to the received control signals.

21. The reception device according to claim 18, further having a housing with a line power plug fastened to it, wherein the reception unit, the audio amplifier unit and the detection device are arranged in the housing.

22. A wireless audio signal transmission system with a reception device according to claim 12.

23. A wireless audio signal transmission system with a reception device according to claim 18.
